(19) United States
(12) Patent Application Publication
(10) Pub. No.: US 2007/0240559 A1
(43) Pub. Date: Oct. 18, 2007

(54) MUSICAL TONE SIGNAL GENERATING APPARATUS

(75) Inventor: Kiyoshi HASEBE, Hamamatsu-shi (JP)

Correspondence Address: ROSSI, KIMMS & McDOWELL LLP., P.O. BOX 826, ASHBURN, VA, 20146-0826, US

(73) Assignee: YAMAHA CORPORATION, Hamamatsu-shi (JP)

(21) Appl. No.: 11/736,154

(22) Filed: Apr. 17, 2007

(30) Foreign Application Priority Data
Apr. 17, 2006 (JP) 2006-112965
Apr. 17, 2006 (JP) 2006-112966

(51) Int. Cl. G10H 1/38; G10H 7/00

(52) U.S. Cl. 84/637

(57) ABSTRACT

A musical tone signal generating apparatus enabling a user to designate a desired chord in a selected key of a piece of music with a simple operation such as operating a numeric key. A chord assigning section assigns numeric keys with respective ones of numeric keys in a key of a piece of music selected by a key selecting section. When any of the numeric keys is operated, a performance control unit reads out, from a chord table, note numbers of chord tones constituting the diatonic chord assigned to the operated numeric key, and outputs sounding instruction data including tone pitch data. In timing in which the sounding instruction data is inputted, a tone generator generates musical tone signals according to the tone pitch data, and causes via a sound system a speaker to sound musical tones.

### BACKGROUND OF THE INVENTION

1. Field of the Invention

The present invention relates to a musical tone signal generating apparatus having numeric keys provided therein for designating a chord or chord tones.

2. Description of the Related Art

An electronic keyboard musical instrument enables a user to perform a chord performance by sequentially operating sets of keys wherein each set of keys corresponds to chord tones. However, with use of a cellular phone or other instrument having no keyboard provided therein, it is difficult for a user to perform a chord performance or a chord designation for automatic accompaniment. Thus, a cellular phone has been known that assigns scale notes in advance to respective ones of numeric keys and generates a tone pitch when a numeric key is operated (refer to Japanese Laid-open Patent Publication No. 2001-197160). However, a user unfamiliar with chord tones for various chords cannot properly operate, at glance of a chord on a musical score, a set of numeric keys assigned with chord tones of the chord.

Also known is an electronic keyboard musical instrument having a single finger mode which performs automatic accompaniment in accordance with chords each designated by a user by pressing a key representing a chord root note, that key being provided in an automatic accompaniment key region. Thus, it appears also possible to provide numeric keys in a cellular phone such as to correspond to respective ones of chord root notes. However, since the root note pitch varies according to the key of a piece of music, a problem is posed that it is difficult for the user at key change to determine which one of the numeric keys is to be operated.

With the aforesaid cellular phone adapted to produce a chord root note and associated chord tones when a corresponding numeric key is depressed, there are always simultaneously produced all the chord tones corresponding to the depressed numeric key. This is enough for a beginner user, but after becoming familiar with it, the user wishes to perform accompaniment using chord tones selected by the user. During a musical performance, however, there is sometimes a chord change, and as a result, the chord root note also changes, posing a problem that the user cannot determine, based on a chord (key and chord type) specified by a musical score or the like, which one of the numeric keys is to be operated.

### SUMMARY OF THE INVENTION

The present invention provides a musical tone signal generating apparatus enabling a user to designate a desired chord in a selected key of a piece of music with a simple operation such as operating a numeric key.

The present invention provides a musical tone signal generating apparatus capable of sounding chord tones in a designated chord, with a simple operation such as operating one or more numeric keys.

According to a first aspect of the present invention, there is provided a musical tone signal generating apparatus comprising numeric keys, a key selecting device, a chord assigning device configured to assign the numeric keys with respective ones of diatonic chords in a key selected by the key selecting device, a performance control device configured to output, when any of the numeric keys is operated, pieces of sounding instruction data used to sound a plurality of chord tones that constitute the diatonic chord assigned to the operated numeric key, and a tone generator configured to generate musical tone signals corresponding to the pieces of sounding instruction data outputted from the performance control device.

A relationship between diatonic chords remains the same irrespective of the key of a piece of music. Thus, with a simple operation such as operating an appropriate numeric key out of the numeric keys assigned with the diatonic chords, it is possible to designate a desired diatonic chord in a selected key of a piece of music and generate chord tones of the designated chord.

According to a second aspect of the present invention, there is provided a musical tone signal generating apparatus comprising numeric keys, a key selecting device, a chord assigning device configured to assign said numeric keys with respective ones of diatonic chords in a key selected by said key selecting device, a performance control device configured to output, when any of said numeric keys is operated, pieces of sounding instruction data used to sound a plurality of chord tones that constitute the diatonic chord assigned to the operated numeric key in accordance with an automatic accompaniment pattern, and a tone generator configured to generate musical tone signals corresponding to the pieces of sounding instruction data outputted from said performance control device.

Thus, with a simple operation such as operating an appropriate numeric key out of the numeric keys assigned with the diatonic chords having a relationship therebetween that remains the same irrespective of the key of a piece of music, it is possible to designate a desired diatonic chord in a selected key and generate chord tones of the designated chord according to an automatic accompaniment pattern. The automatic accompaniment pattern includes, for example, an arpeggio pattern.

According to a third aspect of the present invention, there is provided a musical tone signal generating apparatus comprising numeric keys, a key selecting device, a chord assigning device configured to assign the numeric keys with respective ones of diatonic chords in a key selected by the key selecting device, a performance control device configured to obtain, when any of the numeric keys is operated, an automatic accompaniment pattern corresponding to a diatonic chord assigned to the operated numeric key, and output sounding instruction data for a plurality of musical tones specified by the automatic accompaniment pattern, and a tone generator configured to generate musical tone signals corresponding to the sounding instruction data outputted from the performance control device.

Thus, with a simple operation such as operating an appropriate numeric key out of the numeric keys assigned with the diatonic chords having a relationship therebetween that remains the same irrespective of the key of a piece of music, it is possible to designate a desired diatonic chord in a selected key and generate chord tones of the designated chord according to an automatic accompaniment pattern.

The chord assigning device can assign each of the diatonic chords to a corresponding one of the numeric keys coincident with a numeral of a degree name of that diatonic chord.

In this case, it is easy for a user to understand a relationship between the diatonic chords and the numeric keys that remains unchanged between different keys of a piece of music, whereby a desired diatonic chord can easily be selected.

The musical tone signal generating apparatus can be realized as a cellular phone. In this case, a chord performance can easily be performed by using a cellular phone.

According to fourth to sixth aspects of the present invention, there are provided computer-readable storage media each storing a program for causing a computer to implement a musical tone signal generating method for achieving functions of a corresponding one of musical tone signal generating apparatuses according to the first to third aspect of the present invention.

According to the first to sixth aspects of the present invention, any instrument having neither a keyboard nor a large number of operators but having numeric keys can achieve an advantage of enabling a user to designate a desired diatonic chord in a selected key of a piece of music by a simple operation such as operating a corresponding one of the numeric keys respectively assigned with diatonic chords having a relationship therebetween that remains the same irrespective of the key of a piece of music.

As a result, it is possible with a simple user operation to generate one or more chord tones in a designated diatonic chord, or generate chord tones in a designated diatonic chord according to an automatic accompaniment pattern, or generate musical tones specified by an automatic accompaniment pattern in a designated diatonic chord.

According to a seventh aspect of the present invention, there is provided a musical tone signal generating apparatus comprising numeric keys, a chord designating device, a chord tone assigning device configured to assign the numeric keys with respective ones of chord tones corresponding to a chord designated by the chord designating device in accordance with a scale degree of the chord tone, a performance control device configured to output, when any of the numeric keys is operated, pieces of sounding instruction data of the chord tone assigned to the operated numeric key, and a tone generator configured to generate musical tone signals corresponding to the pieces of sounding instruction data outputted from the performance control device.

Thus, it is possible to easily sound chord tones by operating numeric keys since the scale degrees of the chord tones respectively assigned to the numeric keys do no change even when a chord designated by the chord designating device is changed.

The chord tone assigning device can assign each of the chord tones to a corresponding one of the numeric keys bearing number coincident with a scale degree determined in reference to a root note of the chord. That is, the chord tones are allocated to the chord tones, with the chord root note made to correspond to a first scale degree.

In this case, it becomes easy for a user to understand the chord tones assigned to respective ones of the numeric keys.

The chord tone assigning device can assign a chord tone of an eleventh scale degree to one of the numeric keys bearing number 4, and can assign a chord tone of a thirteenth scale degree to a different one of the numeric keys bearing number 6.

Chord tones having eleventh and thirteenth scale degrees cannot directly be made to correspond to numeric keys bearing numbers “0” to “9”. On the other hand, in a case where chord tones of fourth and sixth scale degrees are not assigned as yet to the numeric keys bearing the numbers 4 and 6, the chord tones of the eleventh and thirteenth scale degrees can be assigned to the numeric keys bearing the numbers 4 and 6 since these chord tones can be inverted to the chord tones of the fourth and sixth scale degrees.

The musical tone signal generating apparatus can further include a display device adapted to display ones of the numeric keys assigned with the chord tones and at least different one of the numeric keys assigned with no chord tone in different display forms.

In this case, it becomes easy for a user to determine which one of the numeric keys is to be operated in order to cause a chord tone to sound, by causing the display device, such as a display unit having a screen and a display unit provided in the numeric keys, to display numeric keys assigned with the chord tones and numeric keys assigned with no chord tones in different display forms.

The musical tone signal generating apparatus can be realized as a cellular phone. In this case, a chord performance can easily be performed by using a cellular phone.

According to an eighth aspect of the present invention, there is provided a computer-readable storage medium storing a program for causing a computer to implement a musical tone signal generating method for achieving functions of a musical tone signal generating apparatus according to the seventh aspect of the present invention.

According to the seventh and eighth aspects of the present invention, any instrument having neither a keyboard nor a large number of operators but having numeric keys can achieve an advantage of capable of easily generating a chord tone by a simple operation such as operating a corresponding one of the numeric keys to which respective ones of chord tones are assigned according to scale degrees that remain the same irrespective of a designated chord. Even when a designated chord is changed, the scale degrees of the chord tones assigned to respective ones of the numeric keys do not change.

Further features of the present invention will become apparent from the following description of exemplary embodiments with reference to the attached drawings.

### BRIEF DESCRIPTION OF THE DRAWINGS

FIG. 1 is a function block diagram showing the construction of a musical tone signal generating apparatus according to a first embodiment of the present invention;

FIG. 2 is a block diagram showing the hardware construction of a cellular phone, which is an example of the musical tone signal generating apparatus shown in FIG. 1;

FIG. 3A is a basic diatonic chord table which is useful in explaining operation of the musical tone signal generating apparatus shown in FIG. 1 and in which note numbers of chord tones of seven diatonic chords for each of C major key and three types of C minor key are arranged;

FIG. 3B is a note number difference value table showing difference number values of chord tones between the key of C and each selected key;

FIG. 3C is a chord tone chord table for the key of G;

FIG. 3D is a chord tone chord table for the key of E flat harmonic minor;

FIG. 4 is a view useful in explaining chord tones sounded when a numeric key is operated in the musical tone signal generating apparatus shown in FIG. 1;

FIG. 5 is a function block diagram showing the construction of a musical tone signal generating apparatus according to a second embodiment of the present invention;

FIG. 6A is a chord tone table for use when the basic chord C is designated which is useful in explaining operation of the musical tone signal generating apparatus shown in FIG. 5 and which shows a relationship between note numbers and scale degrees of chord tones for respective chord names;

FIG. 6B is a shift value table showing differences of chord tones between the key of C and each selected key;

FIG. 6C is a chord tone table for Gm7;

FIG. 6D is a chord tone table for Csus;

FIG. 7A is a view useful in explaining a display form in which images of numeric keys are displayed on a screen of a display device of the musical tone signal generating apparatus shown in FIG. 5 when the chord name Gm7 is assigned; and

FIG. 7B is a view showing an example of numeric key display in a case where the chord name Csus7 is designated.

### DETAILED DESCRIPTION OF THE PREFERRED EMBODIMENTS

The present invention will now be described in detail below with reference to the drawings showing preferred embodiments thereof.

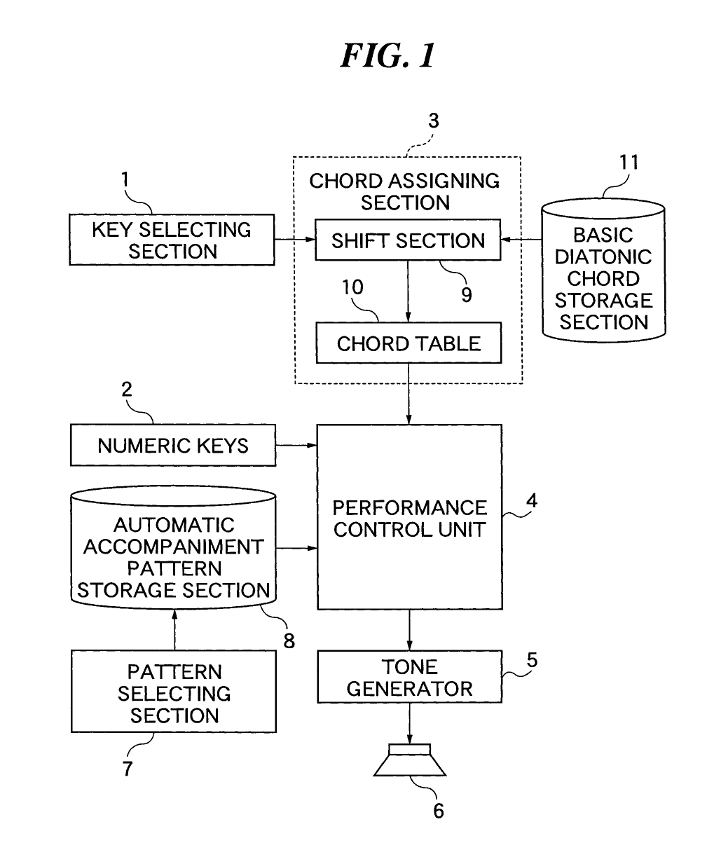

FIG. 1 is a function block diagram showing the construction of a musical tone signal generating apparatus according to a first embodiment of the present invention.

In FIG. 1, reference numeral 1 denotes a key selecting section adapted to select the key of a piece of music, of which a chord performance is to be performed. The key selecting section 1 includes a display device having a display screen on which is displayed a pull-down menu, or a GUI (graphical user interface) having provided therein an input section such as a combo box. In accordance with a selecting instruction inputted by a user by using a predetermined operator (a shift key of a cellular phone, for instance), the key selecting section selects the key of a piece of music. Alternatively, the key selection may be performed by selecting a desired one of a major key and three types of minor keys and then performing a key adjustment such as raising or lowering the selected key by a half tone. Reference numeral 2 denotes numeric keys. In a cellular phone, there are numeric keys bearing numerals “0” to “9” (hereinafter simply referred to as the numeric keys “0” to “9”). Out of these numeric keys, the numeric keys “1” to “7” are used here. Reference numeral 3 denotes a chord assigning section configured to assign diatonic chords in the key selected by the key selecting section 1 to respective ones of the numeric keys “1” to “7”.

These diatonic chords are seven chords built on the diatonic scale. No matter what key is selected, the relationship between the seven chords built on the scale (the array of diatonic chords) is always the same.

To represent diatonic chords, there is known a notation using degree names. The degree names include Roman numerals I, II, III and so on indicating the positions of respective ones of roots of diatonic chords in the diatonic scale, and symbols indicating respective ones of types of the diatonic chords. Thus, the diatonic chords can be represented by the degree names wherein Roman numeral I denotes the root in the key.

This embodiment explains a case where four-notes chords are used, and uses degree names for performing a chord performance. Specifically, a desired chord is designated by a user by operating one of the numeric keys 2 coincident with the Roman numeral of degree name representing the desired chord. The use of degree names is advantageous in that the degree names are the same in notation no matter what key is selected.

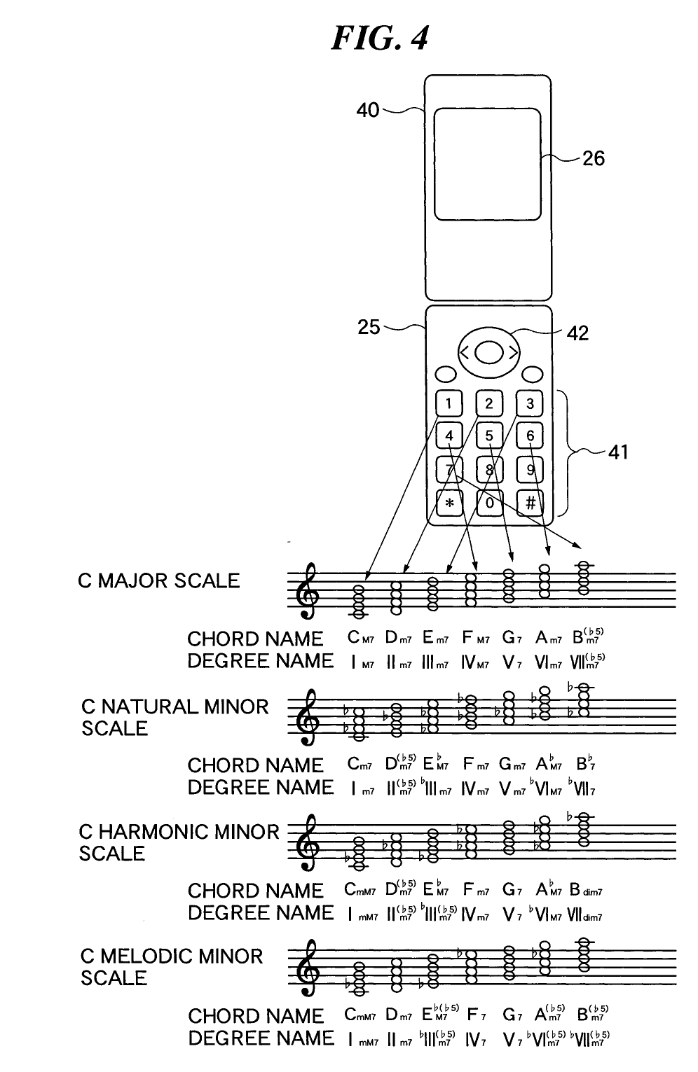

As a specific example, the case where C major shown in FIG. 4 is selected will be explained.

In the key of C major, there are seven diatonic chords whose degree names are respectively represented by Roman numerals I to VII. The Roman numerals I to VII are assigned to number keys “1” to “7” out of the numeric keys 2 shown in FIG. 1.

Diatonic chords, for example, in the key of C major are represented by root note names of C, D, E, F, G, A and B, whereas diatonic chords in the key of G major are represented by root note names of G, A, B, C, D, E, and F, which are different from those in C major. On the other hand, in the case of using degree names, both the diatonic chords in G major and in C major are represented by the same degree names I to VII.

The following is an explanation of the internal construction of the chord assigning section 3. The chord assigning section 3 includes a shift section 9 and a chord table 10, and uses a basic diatonic chord storage section 11 to achieve its own function.

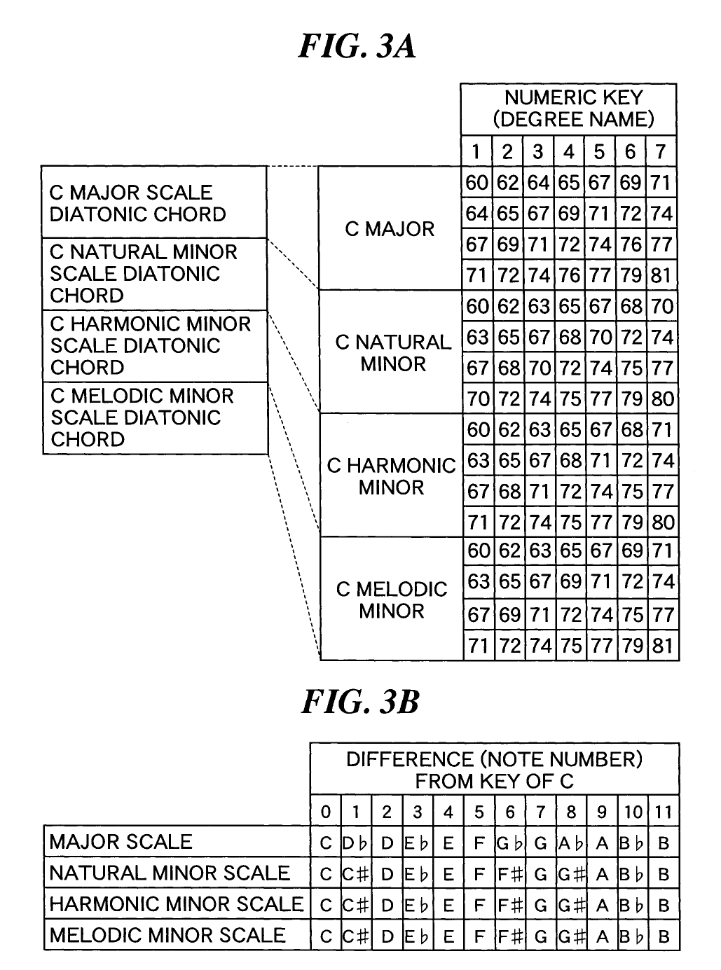

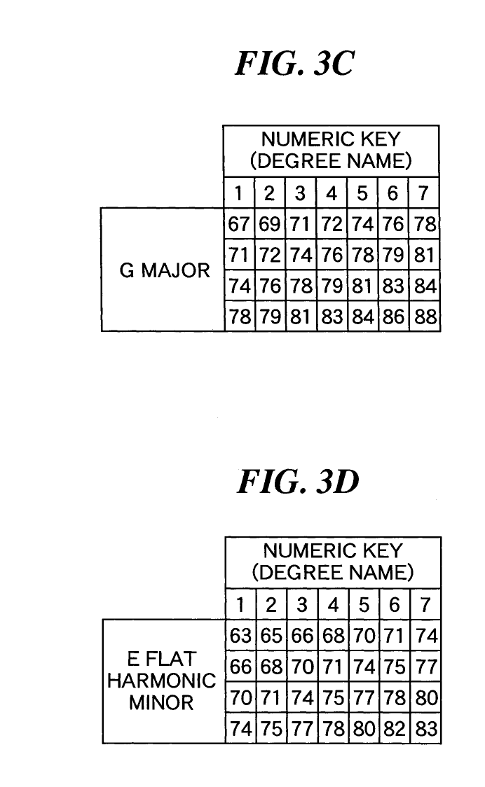

The basic diatonic chord storage section 11 stores a basic diatonic chord table shown in FIG. 3A. In accordance with the key selected by the key selecting section 1, the shift section 9 shifts tone pitches (note numbers) stored in the basic diatonic chord storage section 11. The resultant chord table corresponding to the selected key is stored in the chord table 10. For the tone pitch shifting, a difference value table shown in FIG. 3B may be referred to. Alternatively, calculation may be performed. The chord table 10 stores tone pitches (note numbers) of chord tones of each chord so as to correspond to the degree name indicating the chord, as shown by way of example in FIGS. 3C and 3D.

Reference numeral 4 denotes a performance control unit adapted to output, when detecting any of the numeric keys 2 being operated (pressed), sounding instruction data used to sound chord tones constituting a diatonic chord assigned to the operated numeric key.

More specifically, the performance control unit 4 reads out, from the chord table 10, the tone pitches (note numbers) of chord tones constituting the diatonic chord assigned to the operated numeric key 2 (i.e., the diatonic chord having a degree name coincident with the number on the operated numeric key 2), and outputs sounding instruction data including pitch data to a tone generator 5. It should be noted that the pitch data, which are parameters used to control the tone generator, are not limited to being note numbers.

Based on the pitch data, the tone generator 5 generates musical tone signals in timing in which the sounding instruction data is inputted from the performance control unit 4, thereby causing, via a sound system (not shown), a speaker 6 to sound musical tones. When the numeric key 2 is no longer operated (is released from being pressed), muting instruction data is outputted to the tone generator 5, whereby the musical tone signal is attenuated. In the case that the musical tone signal is one used to produce an attenuating musical tone such as a piano tone, it is unnecessary to use the muting instruction data.

Since a user is likely to get tired of simply sounding chord tones, an automatic accompaniment may be performed using chord tones according to an automatic accompaniment pattern, as in the case of a conventional automatic accompaniment apparatus including an arpeggiator.

In this connection, an automatic accompaniment pattern storage section 8 stores a plurality of types of automatic accompaniment patterns. A pattern selecting section 7 selects an automatic accompaniment pattern in advance.

When any of the numeric keys 2 is operated, the performance control unit 4 outputs sounding instruction data in accordance with which chord tones constituting a diatonic chord assigned to the operated numeric key 2 are sounded according to the automatic accompaniment pattern.

More specifically, in accordance with the automatic accompaniment pattern, the performance control unit 4 selects, in a predetermined order, the tone pitches (note numbers) of the chord tones obtained from the chord assigning section 3, and outputs pieces of sounding instruction data to the tone generator 5 in different sounding timings.

The automatic accompaniment is achieved by, for example, an arpeggiator function of producing arpeggio in response to a key depressing operation. In this case, an arpeggio pattern is stored, which is data in which key numbers (note orders) are made correspond to their sounding timings, the key numbers (note orders) being respectively allocated with designated tones according to a predetermined rule (for instance, in the ascending order of tone pitch).

When each sounding timing specified in the arpeggio pattern is reached, data for sounding a tone allocated with a key number (note order) is outputted to the tone generator 5.

In this embodiment, by using chord tones of a designated chord as the designated tones and using an arpeggio pattern as the automatic accompaniment pattern, the arpeggio of the chord designated by the numeric key 2 can be sounded from the tone generator 5 while the numeric key 2 is kept depressed, for example.

To this end, the performance control unit 4 outputs sounding instruction data to the tone generator 5. The sounding instruction data is used to sound, in accordance with the arpeggio pattern stored in the automatic accompaniment pattern storage section 8, chord tones constituting a chord assigned to the operated numeric key 2.

It should be noted that a desired pattern other than the pattern for sounding arpeggio may be stored as the automatic accompaniment pattern.

The performance control unit 4 may be configured such as to obtain, when any of the numeric keys 2 is operated, an automatic accompaniment pattern corresponding to the diatonic chord assigned to the operated numeric key 2, and output sounding instruction data for production of musical tones specified by the automatic accompaniment pattern.

More specifically, the performance control unit 4 obtains from the chord assigning section 3 chord designation data (including the key on which diatonic chords are built and numerals representing the degree names of the diatonic chords, for instance) assigned to the operated numeric key, obtains from the automatic accompaniment data storage section 8 a part of the automatic accompaniment pattern (including pitch data) for one or a few bars of a piece of music corresponding to the chord designation data, and outputs to the tone generator 5 sounding instruction data used for production of musical tones whose tone pitches and sounding timings are specified by the obtained automatic accompaniment pattern. In this case, tone pitches (note numbers) of chord tones stored in the chord table 10 are not used for musical tone production. Tone pitches of musical tones included in the automatic accompaniment pattern may not be equal to tone pitches of chord tones of designated chords.

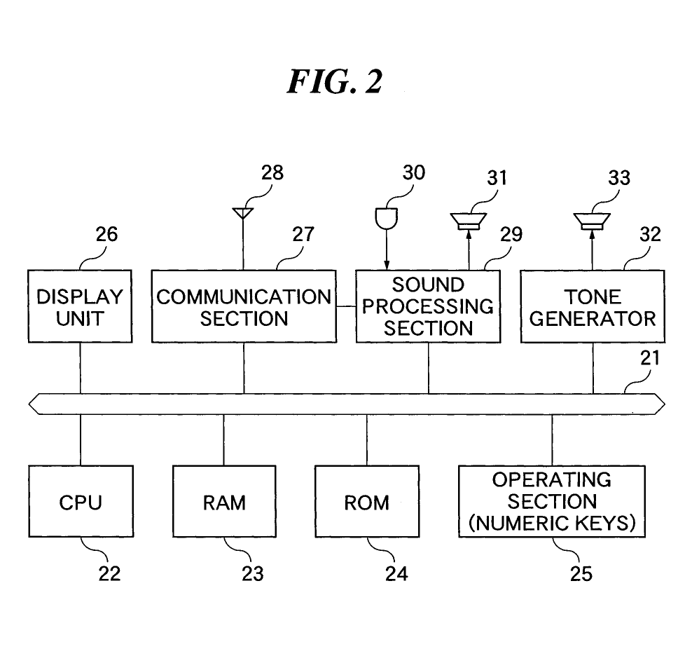

FIG. 2 is a block diagram showing the hardware construction of a cellular phone, which is an example of the musical tone signal generating apparatus shown in FIG. 1.

In FIG. 2, reference numerals 21 to 24 denote a bus, a CPU (central processing unit), a RAM (random access memory), and a ROM (read only memory), respectively. In the case that the ROM 24 is at least partly formed by a flush ROM, data can be written into the ROM 24. In accordance with a control program stored in the ROM 24 and with use of the RAM 23 as a main memory, the CPU 22 controls a communication section 27 and a sound processing section 29 which are connected to the bus 21, thereby controlling a telephone system. Reference numerals 28, 30 and 31 denote an antenna, a telephone transmitter (microphone), and a telephone receiver (speaker), respectively.

By operating an operating section 25 (which includes numeric keys and a shift key) while referring to contents displayed on a display unit 26, a user can input a telephone number and can send and receive a telephone message. The user can also input an instruction to browse a web page or download musical composition data via the Internet or execute an application program or the like. Such an application program can also be downloaded from a server on a network.

Reference numerals 32 denotes a tone generator, and 33 denotes a speaker. When an incoming call is received, the tone generator 32 generates musical tone signals corresponding to predetermined melody performance data stored in the ROM 24 or the RAM 23, and musical tones are sounded from the speaker 33.

The functions of the chord assigning section 3 and the performance control unit 4 of the musical tone signal generating apparatus shown in FIG. 1 are realized by an application program for a game, musical performance or the like stored in the ROM 24 or the RAM 23 being executed by the CPU 22. As a result, musical tone signals are generated from the tone generator 32 and musical tones are sounded from the speaker 33. The function of the tone generator 32 is sometimes realized by a software tone generator program being executed by the CPU 22.

FIGS. 3A to 3D are tables useful in explaining operation of the musical tone signal generating apparatus shown in FIG. 1.

FIG. 3A is a table showing stored contents in the basic diatonic chord storage section 11 shown in FIG. 1. In the table in FIG. 3A, tone pitches (note numbers) of chord tones of seven diatonic chords for each of C major key and three types of C minor key (four types of key in total) are arranged, with a root note of a tonic chord represented by a note number 60. Arabic numerals “1” to “7” in the uppermost part of the table are degree names of the diatonic chords represented by a numeric notation (usually, the degree names are represented by Roman numerals). Beneath each of Arabic numerals (degree names) “1” to “7”, there is a vertical column divided into four sections, and in each section, four numerals representing tone pitches (note numbers) of chord tones are shown.

With reference to FIG. 4, an explanation will be given of C major key as an example. In FIG. 4, Roman numerals (degree names) I, IV, and V represent respective ones of a tonic chord, a subdominant chord, and a dominant chord. Chords are sometimes represented by chord names as shown in FIG. 4. Each chord name is represented by a root note name in combination with a chord type. In this embodiment, each numeral (degree name) indicating a chord is assigned to a numeric key 2 bearing the same number. Thus, using the numeric keys 2, various chords can be designated with extremely ease.

When the key of G major is selected by the key selecting section 1, the shift section 9 shown in FIG. 1 adds “7” to respective ones of the note numbers of chord tones in the key of C major and writes the resultant note numbers in the chord table 10 shown in FIG. 1 since the key of G major is a key which is obtainable by shifting the key of C major by seven halftones (i.e., which is larger in note number by “7” than the key of C major).

At the time of referring to the note number difference table in FIG. 3B, a column including a symbol “G” is searched for from twelve columns in a “major scale” row, and then a numeral indicated just above the searched column is referred to. A numeral of “7” indicated just above the column including the symbol “G” represents that a note number difference value between the keys of C and G is equal to “7”. Thus, the shift section 9 in FIG. 1 adds “7” to respective ones of the note numbers of the chord tones in C major scale in FIG. 3A, thereby obtaining a chord tone table shown in FIG. 3C.

When the key of E flat harmonic minor is selected by the key selecting section 1, the shift section 9 adds “3” to the note numbers of the chord tones in C harmonic minor scale in FIG. 3A and writes the resultant note numbers into the chord table 10 in FIG. 1. Using the table in FIG. 3B, a numeral of “3” can be obtained which is indicated right above a column including a symbol “E flat” and which represents a difference value between the keys of E flat and C.

When no key is selected by the key selecting section 1, the chord table for C major is retained in the chord table 10.

The chord assigning section 3 is not limited to the construction illustrated in FIGS. 1 and 3. In a case where the chord assigning section 3 has a sufficient memory capacity, note numbers of chord tones of diatonic chords in all the keys may be stored in the chord table 10 instead of calculating them in the shift section 9.

FIG. 4 is a view useful in explaining chord tones sounded when a numeric key is operated in the musical tone signal generating apparatus shown in FIG. 1.

In FIG. 4, like parts common to FIG. 2 are denoted by like numerals. Reference numeral 40 denotes a cellular phone; 26, a display unit; 25, an operating section; 41, input keys including numeric keys 0-9, an asterisk key, a sharp key, and the like; and 42, a shift key.

FIG. 4 shows which one (numeric key) of the input keys 41 should be pressed in order to sound a desired diatonic chord (consisting of chord tones) when one of C major and three types of C minor is selected.

Although not explained with reference to FIG. 1, sounding instruction data for specifying tone pitches of chord tones to be sounded, which are one octave higher (or lower) than the tone pitches assigned by the chord assigning section 3, may be outputted to the tone generator 5 when and after a right side part (or left side part) of the shift key 42 is pressed.

In the above the case where four-notes chords are used as diatonic chords has been explained, but triad chords or chords including four-notes chord tones and triad chord tones may be used. For example, as the tonic chord, a C chord (triad) is often used instead of a CM7 chord (four-notes chord). For the subdominant chord, an F chord (triad) is sometimes used. For the dominant chord, a G7 chord (four-notes chord) is used.

Therefore, in the basic diatonic chord table storage section 11 shown in FIG. 3A, a plurality of types of chord groups including not only four-note chords but also triad chords and chords including four-notes chord tones and triad chord tones may be stored in advance, and desired chords may be selected therefrom using a selecting operator.

In the above, the cellular phone 40 has been explained as an example. However, the present invention can be realized not only using the cellular phone 40 but also using a personal computer, a PDA (personal digital assistant), a game machine, a potable music player, or the like as long as numeric keys are provided therein. The present invention may also be achieved using an electronic keyboard musical instrument having provided therein numeric keys, which are usually used for when the settings of the electronic keyboard instrument are performed.

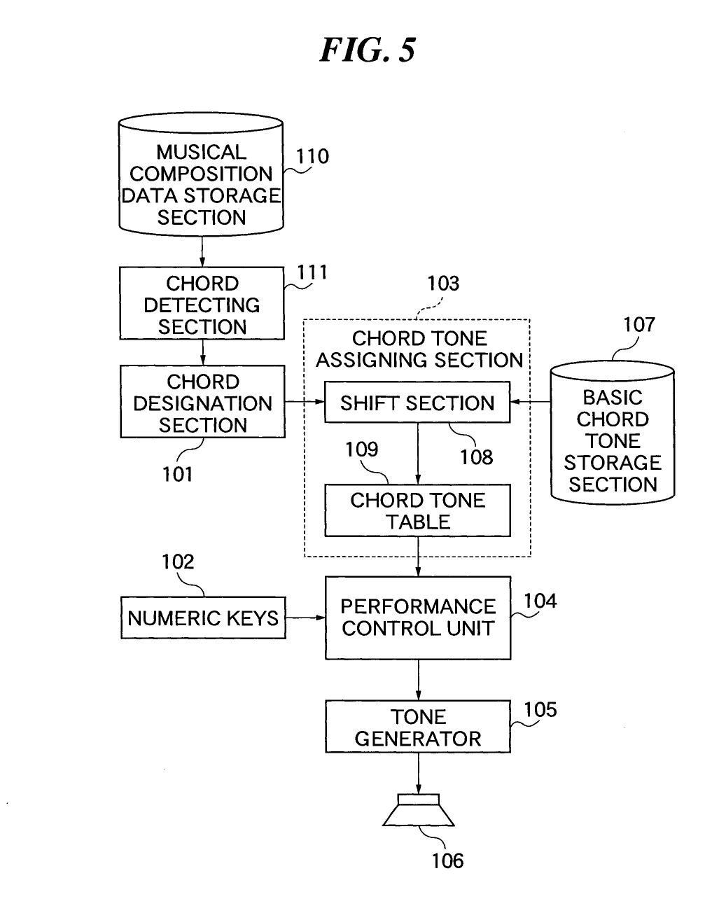

FIG. 5 is a function block diagram showing the construction of a musical tone signal generating apparatus according to a second embodiment of the present invention.

In FIG. 5, reference numeral 101 denotes a chord designation section adapted to designate a chord by use of a chord name, the chord name being specified by a key (root note) and a chord type. Reference numeral 102 denotes numeric keys. In a cellular phone, there are provided numeric keys bearing key number “0” to “9” (hereinafter referred to as numeric keys “0” to “9”). Out of them, numeric keys “1” to “9” are used in this embodiment. Reference numeral 103 denotes a chord tone assigning section configured to assign the numeric keys 102 with respective ones of chord tones of a chord designated by the chord designation section 101 in accordance with note intervals, i.e., scale degrees (information on relative numeric values each measured from a root note) of the chord tones. Even when the chord designation changes, the note interval (scale degree) of a chord tone assigned to a corresponding numeric key does not change.

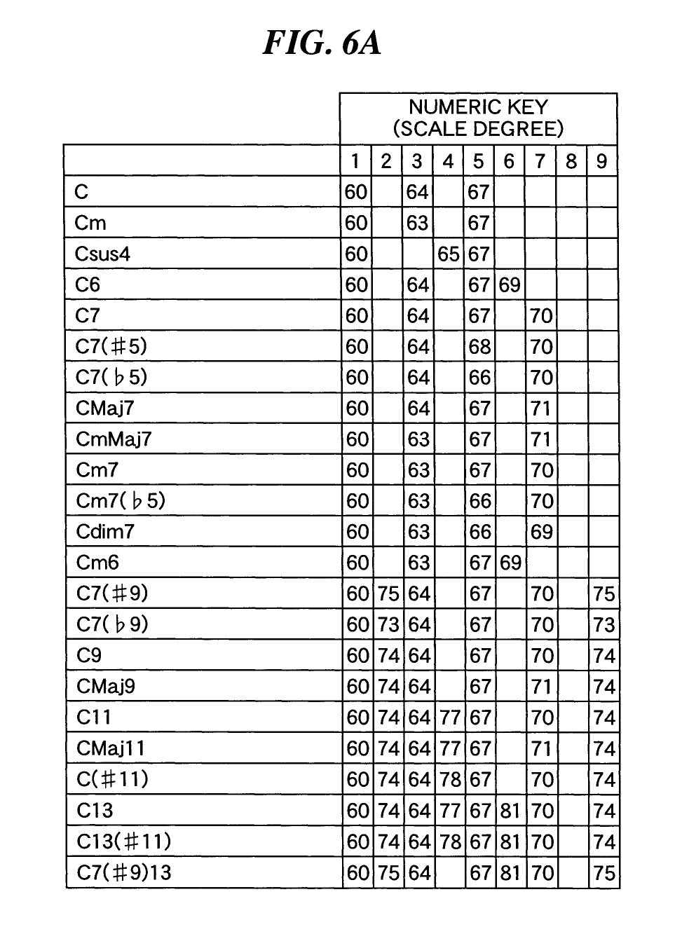

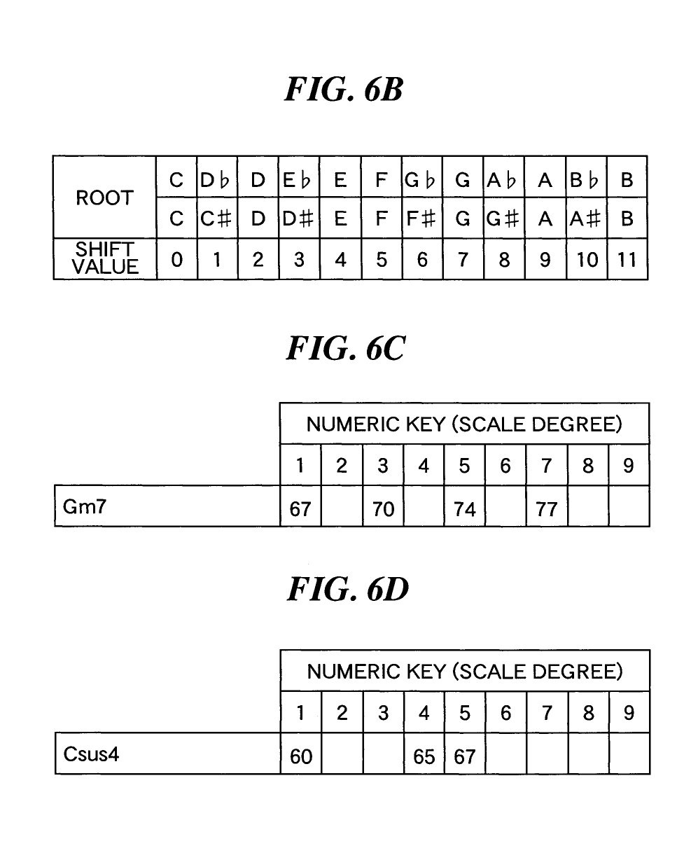

The chord tone assigning section 103 includes a shift section 108 and a chord tone table 109, and is adapted to realize its function using a basic chord tone storage section 107 in which is stored a basic chord tone table shown in FIG. 6A. The basic chord tone table is a chord tone table for use when the basic chord C is designated in the chord designation. This table shows a relationship between tone pitches (note numbers) and scale degrees (note intervals from the root) of chord tones for respective chord names (chord types). The scale degrees do not change even if the designated chord is changed. Thus, the tone pitch array (the relationship between tone pitches and scale degrees) also does not change even when the designated chord is changed. It should be noted that FIG. 6A shows typical chord types, with other chord types omitted.

The scale degrees “1” to “9” of chord tones indicate note intervals of the chord tones from a root note with scale degree “1”. In this embodiment, a chord tone is allocated to a corresponding numeric key 102 bearing the key number that is the same as the scale degree of the chord tone. In the case of using numeric keys “0” to “9”, eleventh and thirteenth notes in chord tones cannot be directly allocated to any of the numeric keys. However, the eleventh and thirteenth notes can advantageously be allocated to the numeric keys “4” and “6”, respectively, as explained below.

An eleventh chord tone can be inverted to a fourth tone. The fourth tone is frequently a non-chord tone, and is not in use in that case. Similarly, a thirteenth chord tone can be inverted to a sixth tone, which is frequently a non-chord tone and in that case is not in use. The allocation of eleventh and thirteenth chord tones to the numeric keys “4” and “6” does not produce odd feelings from the view point of chord theory, and is thus advantageous.

A ninth chord tone can be allocated to the numeric keys “2”. In that case, a ninth chord tone is sounded when either one of the numeric keys “2” and “9” is operated.

Thus, the ninth, eleventh and thirteenth tension notes can be made to correspond to numerals in the range “1” to “7”. This facilitates execution of a chord tone performance using an instrument having provided therein a less number of operation keys.

In accordance with the chord designated by the chord designation section 101, the shift section 108 shifts tone pitches (note numbers) stored in the basic chord tone table storage section 10, thereby obtaining a chord tone table for the designated chord, which is then stored in the chord tone table storage section 109. In other words, the basic chord tone table is used after being shifted according to the designated chord. For the tone pitch shifting, calculation may be performed or a shift value table shown in FIG. 6B may be referred to.

As shown by way of example in FIGS. 6C and 6D, tone pitches (note numbers) of chord tones are stored in the chord tone table 109 so as to correspond to scale degrees thereof, with a chord root note being a first scale degree.

Reference 104 denotes a performance control unit configured to output sounding instruction data corresponding to a chord tone assigned to the operated numeric key 102. More specifically, when detecting a numeric key 102 being operated (depressed), the performance control unit 104 reads out from the chord tone table 109 the tone pitch (note number) of the chord tone assigned to the operated numeric key 102, and outputs sounding instruction data including pitch data to a tone generator 105. The pitch data is a parameter for control of the tone generator, and is not necessarily being a note number.

The tone generator 105 generates a musical tone signal in accordance with the sounding instruction data outputted from the performance control unit 4, and operates speaker 106 via a sound system, not shown, to generate a musical tone. When the numeric key 102 is no longer operated (is released from being pressed), muting instruction data is outputted to the tone generator 5, whereby the musical tone signal is attenuated. In the case that the musical tone signal is one used to produce an attenuating musical tone such as a piano tone, it is unnecessary to use the muting instruction data.

The user may arbitrarily designate a chord using an operator of the chord designation section 101. Alternatively, a chord may be designated according to chord designation data (chord change data) detected by a chord detecting section 111 while musical composition data is read out from a musical composition data storage section 110, with the progress of performance of music composition. The data storage section 101 stores a musical composition data file including one or more pieces of chord designation data (chord change data). The chord designation data (chord change data) may be included in the musical composition data file, as meta-event in an SMF (standard MIDI file), which is one of specifications for a musical composition data file.

For execution of an automatic performance, a user simply permits sounding instruction data for a melody part of a musical composition data file to be outputted to the tone generator 5.

A accompaniment performance according to a chord can be performed by a user by operating one or more numeric keys assigned with chord tones of a designated chord and by chord designation data (chord change data) being detected from a musical composition data file.

As in the apparatus of the first embodiment shown in FIG. 1, the musical tone signal generating apparatus of this embodiment shown in FIG. 5 can be realized as a cellular phone which is shown by way of example in FIG. 2.

The functions of the chord tone assigning section 103 and the performance control unit 104 of the musical tone signal generating apparatus in FIG. 5 are realized by an application program stored in the ROM 24 or the RAM 23 in FIG. 2 being executed by the CPU 22. In that case, a musical tone signal is generated by the tone generator 32 and a musical tone is sounded from the speaker 33. The function of the tone generator 32 is realized in some cases by a software tone generator program being executed by the CPU 22.

FIGS. 6A to 6D are tables useful in explaining operation of the musical tone signal generating apparatus shown in FIG. 5.

FIG. 6A is a table showing stored contents in the basic chord tone storage section 107 in FIG. 5.

As already explained, the basic chord tone table in FIG. 6A stores chord names and tone pitches (note numbers) of chord tones for a plurality of types of chords. These chords each have a C root note (note number 60) and are distinguished from one another by their chord names. Each chord name is represented by a root note name in combination with a chord type (such as major triad, minor triad, augmented triad, diminished triad, seventh chord, sixth chord, or the like). This table includes rows each including a chord name and tone pitches (note numbers) of chord tones concerned. Arabic numerals “1” to “9” in the uppermost row of the table are scale degrees of chord tones, which indicate note intervals from a root note with scale degree “1”.

By way of example, a C major triad is comprised of the first degree note C with note number 60, the third degree note E with note number 64, and the fifth degree note G with note number 67.

According to the present embodiment, chord tones of each chord can extremely easily be designated since the scale degrees indicating intervals from the root are assigned in advance to the numeric keys 102 bearing the same numbers as respective ones of the scale degrees, thereby enabling a user to designate a desired scale degree (chord tone) by operating a corresponding numeric key.

The basic chord tone table is a chord tone table solely showing chords in the key of C (with C root note). To obtain any chord tones belonging to a chord designated by the chord designation section 101, the shift section 108 shown in FIG. 5 calculates a difference value between a selected key and the key of C (between a root note in the selected key and the C root note in the key of C). Alternatively, the shift section 108 obtains chord tones using a shift value table. The following is an explanation of an example where chords actually designated are used.

In the case, for example, where a chord name Gm7 (minor triad) in the key of G with a G root note is designated by the chord designation section 101, a row corresponding to C minor seventh (Cm7) is read out from the basic chord tone table shown in FIG. 6A.

Next, the chord designation section 101 refers to the shift value table shown in FIG. 6B to find a column in which a symbol “G” is shown from twelve columns in a “shift value” row of the table, and then determines a shift value of “7” indicated in that column. The shift value “7” represents atone pitch difference between the keys of C and G.

Thus, a value of “7” is added to respective ones of note numbers “60, -, 63, -, 67, -, 70, -, -” indicating tone pitches of chord tones shown in the row that corresponds to the chord name Cm7 in the key of C in FIG. 6A. As a result, a chord tone table is obtained as shown in FIG. 6C, and is then written into the chord tone table 109 in FIG. 5.

When a chord name “C suspended fourth (Csus)” is selected by the chord designation section 101, a shift value of “0” is determined from the shift value table. Therefore, the note numbers “60, -, -, 65, 67, -, -, -, -” indicating tone pitches of chord tones in the row corresponding to the chord name “suspended fourth (Csus)” in the key of C shown in the basic chord tone table of FIG. 6A are written into the chord tone table 109 in FIG. 5.

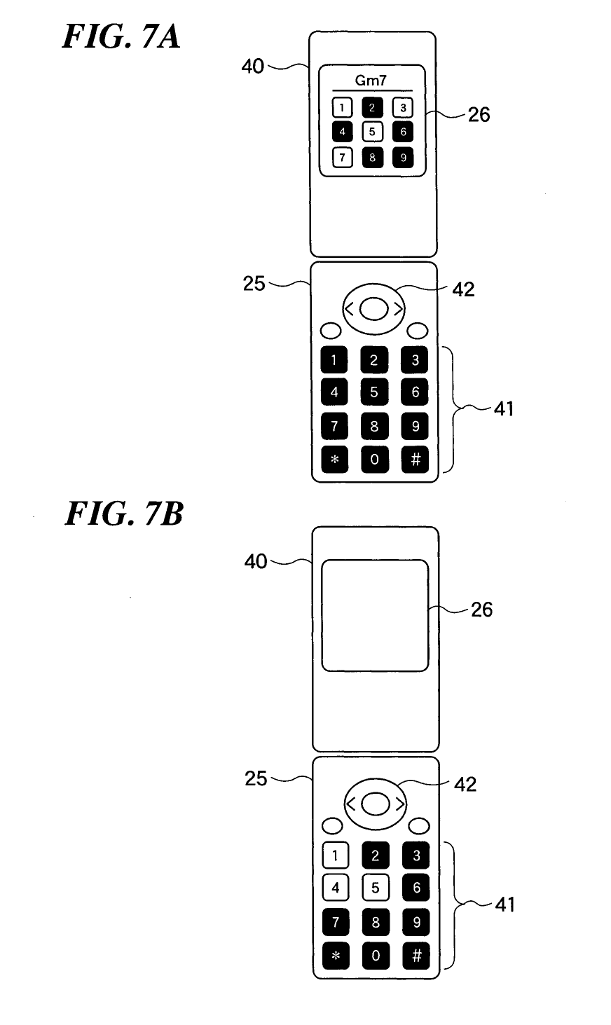

FIGS. 7A and 7B are views useful in explaining a display form in a display device of the musical tone signal generating apparatus in FIG. 5.

In FIGS. 7A and 7B, reference numeral 40 denotes a cellular phone; 25, an operating section; 41, input keys (including numeric keys, an asterisk key, a sharp key, etc.); 42, a shift key; and 26, a display device. In the following, a display method for enabling a user to easily determine a numeric key to be operated will be explained. Referring to FIG. 7A, images of at least the numeric keys of the input keys 41 are displayed on a screen of the display device 26.

The chord tone assigning section 103 is capable of determining one or more scale degrees to which one or more chord tones have been assigned and also determining one or more scale degrees to which no chord tone has been assigned. The image display is performed in different forms between one or more numeric keys of the input keys 41 (hereinafter simply referred to as the numeric keys 41) each bearing the same number as the scale degree assigned with chord tone and one or more other numeric keys 41 bearing the same numbers as the scale degrees assigned with no chord tone.

FIG. 7A shows the image display observed when the chord name Gm7 exemplarily shown in FIG. 6C is assigned.

For example, the images of numeric keys “1”, “3”, “5” and “7” to which chord tones are assigned are displayed in yellow in color, whereas the numeric keys “2”, “4”, “6”, “8” and “9” corresponding to non-chord tones are displayed in gray.

In another example shown in FIG. 7B, the input keys 41 are themselves displayed in different forms between one or more numeric keys 41 each bearing the same number as the corresponding scale degree assigned with chord tone and one or more numeric keys 41 each bearing the same number as the scale degree to which no chord tone is assigned. For example, the numeric keys 41 may be comprised of buttons having built-in LEDs or other lights (not shown) which can be selectively switched on and off or can be changed in color. In that case, the display device 26 can also be used for other display application.

FIG. 7B shows an example of numeric key display in a case where the chord name Csus7 shown in FIG. 6D is designated. In this example, LEDs of numeric keys “1”, “4” and “5” corresponding to chord tones are switched on, whereas LEDs of the other numeric keys corresponding to non-chord tones are switched off.

The form in which numeric keys assigned with tension notes (ninth, eleventh and thirteenth notes) are displayed may be made different from the form in which numeric keys assigned with other chord tones are displayed.

In the aforementioned two examples, when chord tones are changed as a result of a chord change in the chord designation section 101, the form in which numeric keys are displayed changes.

When a numeric key 41, such as numeric key “2”, to which no chord tone is assigned (i.e., for which no note number is stored) is operated, no musical tone is sounded. On the other hand, when a numeric key 41 to which a chord tone is assigned is operated, a musical tone is sounded at a tone pitch of the assigned chord tone. For example, when the numeric key “1” is pressed with the chord “Gm7” designated, a sounding instruction with note number “67” is issued, and a muting instruction is issued when the numeric key “1” is released from being depressed.

Although not explained with reference to FIG. 5, sounding instruction data for designating tone pitches of chord tones to be sounded, which are one octave higher (or lower) than the tone pitches assigned by the chord assigning section 3, may be outputted to the tone generator 5 when and after a right side part (or left side part) of the shift key 42 is pressed.

In the above, the cellular phone 40 has been explained as an example. However, the present invention can be realized not only using the cellular phone 40 but also using a personal computer, a PDA (personal digital assistant), a game machine, a potable music player, or the like as long as numeric keys are provided therein. Furthermore, using an electronic keyboard musical instrument having provided therein numeric keys used for when the settings thereof are performed, the present invention may also be achieved.

It is to be understood that the present invention can also be attained by supplying to a system or apparatus a storage medium in which is stored a program code of software that realizes the functions of embodiments as described above, and then causing a computer (or CPU, MPU, etc.) of the system or apparatus to read out and execute the program code stored in the storage medium.

In this case, the program code itself read out from the storage medium realizes the functions of the embodiments, and hence the program code and the storage medium in which the program code is stored constitute the present invention.

The storage medium used for supplying the program code may be, for example, a floppy™ disk, a hard disk, a magnetic-optical disk, an optical disk such as a CD-ROM, a CD-R, a CD-RW, a DVD-ROM, a DVD-RAM, a DVD-RW or a DVD+RW, a magnetic tape, a nonvolatile memory card, or a ROM. Alternatively, the program code may be downloaded via a network.

Moreover, it is to be understood that the functions of the embodiments can be accomplished not only by executing a program code read out by the computer, but also by causing an OS (operating system) or the like which operates on the computer to perform a part or all of the actual operations based on instructions of the program code.

Furthermore, it is to be understood that the functions of the embodiments can also be accomplished by writing a program code read out from a storage medium into a memory provided on an expansion board inserted into the computer or in an expansion unit connected to the computer and then causing a CPU or the like provided on the expansion board or in the expansion unit to perform a part or all of the actual operations based on instructions of the program code.

What is claimed is:

1. A musical tone signal generating apparatus comprising:
numeric keys;
a key selecting device;
a chord assigning device configured to assign said numeric keys with respective ones of diatonic chords in a key selected by said key selecting device;
a performance control device configured to output, when any of said numeric keys is operated, pieces of sounding instruction data used to sound a plurality of chord tones that constitute the diatonic chord assigned to the operated numeric key; and
a tone generator configured to generate musical tone signals corresponding to the pieces of sounding instruction data outputted from said performance control device.

2. A musical tone signal generating apparatus comprising:
numeric keys;
a key selecting device;
a chord assigning device configured to assign said numeric keys with respective ones of diatonic chords in a key selected by said key selecting device;
a performance control device configured to output, when any of said numeric keys is operated, pieces of sounding instruction data used to sound a plurality of chord tones that constitute the diatonic chord assigned to the operated numeric key in accordance with an automatic accompaniment pattern; and
a tone generator configured to generate musical tone signals corresponding to the pieces of sounding instruction data outputted from said performance control device.

3. A musical tone signal generating apparatus comprising:
numeric keys;
a key selecting device;
a chord assigning device configured to assign said numeric keys with respective ones of diatonic chords in a key selected by said key selecting device;
a performance control device configured to obtain, when any of said numeric keys is operated, an automatic accompaniment pattern corresponding to a diatonic chord assigned to the operated numeric key, and output sounding instruction data for a plurality of musical tones specified by the automatic accompaniment pattern; and
a tone generator configured to generate musical tone signals corresponding to the sounding instruction data outputted from said performance control device.

4. The musical tone signal generating apparatus according to claim 1, wherein said chord assigning device assigns each of the diatonic chords to a corresponding one of said numeric keys coincident with a numeral of a degree name of that diatonic chord.

5. The musical tone signal generating apparatus according to claim 2, wherein said chord assigning device assigns each of the diatonic chord to a corresponding one of said numeric keys coincident with a numeral of a degree name of that diatonic chord.

6. The musical tone signal generating apparatus according to claim 3, wherein said chord assigning device assigns each of the diatonic chord to a corresponding one of said numeric keys coincident with a numeral of a degree name of that diatonic chord.

7. The musical tone signal generating apparatus according to claim 1, wherein the musical tone signal generating apparatus is realized as a cellular phone.

8. The musical tone signal generating apparatus according to claim 2, wherein the musical tone signal generating apparatus is realized as a cellular phone.

9. The musical tone signal generating apparatus according to claim 3, wherein the musical tone signal generating apparatus is realized as a cellular phone.

10. A computer-readable storage medium storing a program for causing a computer to implement a musical tone signal generating method for a musical tone signal generating apparatus having numeric keys, a key selecting device, and a tone generator, the method comprising:
a chord assigning step of assigning the numeric keys with respective ones of diatonic chords in accordance with a key selected by the key selecting device;
a performance control step of outputting, when any of the numeric keys is operated, pieces of sounding instruction data used to sound a plurality of chord tones that constitute a diatonic chord assigned to the operated numeric key; and
a musical tone signal generating step of generating musical tone signals corresponding to the pieces of sounding instruction data outputted from said performance control step.

11. A computer-readable storage medium storing a program for causing a computer to implement a musical tone signal generating method for a musical tone signal generating apparatus having numeric keys, a key selecting device, and a tone generator, the method comprising:
a chord assigning step of assigning the numeric keys with respective ones of diatonic chords in a key selected by the key selecting device;
a performance control step of outputting, when any of the numeric keys is operated, pieces of sounding instruction data used to sound a plurality of chord tones that constitute a diatonic chord assigned to the operated numeric key in accordance with an automatic accompaniment pattern; and
a musical tone signal generating step of generating musical tone signals corresponding to the pieces of sounding instruction data outputted from said performance control step.

12. A computer-readable storage medium storing a program for causing a computer to implement a musical tone signal generating method for a musical tone signal generating apparatus having numeric keys, a key selecting device, and a tone generator, the method comprising:
a chord assigning step of assigning the numeric keys with respective ones of diatonic chords in a key selected by the key selecting device;
a performance control step of obtaining, when any of the numeric keys is operated, an automatic accompaniment pattern corresponding to a diatonic chord assigned to the operated numeric key, and outputting sounding instruction data for a plurality of musical tone specified by the automatic accompaniment pattern; and
a musical tone signal generating step of generating musical tone signals corresponding to the sounding instruction data outputted from said performance control step.

13. A musical tone signal generating apparatus comprising:
numeric keys;
a chord designating device;
a chord tone assigning device configured to assign said numeric keys with respective ones of chord tones corresponding to a chord designated by said chord designating device in accordance with a scale degree of the chord tone;
a performance control device configured to output, when any of said numeric keys is operated, pieces of sounding instruction data of the chord tone assigned to the operated numeric key; and
a tone generator configured to generate musical tone signals corresponding to the pieces of sounding instruction data outputted from said performance control device.

14. The musical tone signal generating apparatus according to claim 13, wherein said chord tone assigning device assigns each of the chord tones to a corresponding one of said numeric keys bearing number coincident with a scale degree determined in reference to a root note of the chord tone.

15. The musical tone signal generating apparatus according to claim 14, wherein said chord tone assigning device assigns a chord tone of an eleventh scale degree to one of said numeric keys bearing number 4, and assigns a chord tone of a thirteenth scale degree to a different one of said numeric keys bearing number 6.

16. The musical tone signal generating apparatus according to claim 13, further including:
a display device adapted to display ones of said numeric keys assigned with the chord tones and at least different one of said numeric keys assigned with no chord tone in different display forms.

17. The musical tone signal generating apparatus according to claim 13, wherein the musical tone signal generating apparatus is realized as a cellular phone.

18. A computer-readable storage medium storing a program for causing a computer to implement a musical tone signal generating method for a musical tone signal generating apparatus having numeric keys, a chord designating device, and a tone generator, the method comprising:
a chord tone assigning step of assigning the numeric keys with respective ones of chord tones corresponding to a chord designated by the chord designating device in accordance with a scale degree of the chord tone;
a performance control step of outputting, when any of the numeric keys is operated, pieces of sounding instruction data of the chord tone assigned to the operated numeric key; and
a musical tone generating step of generating musical tone signals corresponding to the pieces of sounding instruction data outputted from said performance control step.
